(19) United States
(12) Patent Application Publication
(10) Pub. No.: US 2009/0301395 A1
(43) Pub. Date: Dec. 10, 2009

(54) PLATING APPARATUS AND PLATING METHOD

(76) Inventors: Masahiko SEKIMOTO, Tokyo (JP); Yasuhiko Endo, Tokyo (JP); Stephen Strausser, Sacramento, CA (US); Takashi Takemura, Tokyo (JP); Nobutoshi Saito, Tokyo (JP); Fumio Kuriyama, Tokyo (JP); Junichiro Yoshioka, Tokyo (JP); Kuniaki Horie, Tokyo (JP); Yoshio Minami, Tokyo (JP); Kenji Kamoda, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/543,832

(22) Filed: Aug. 19, 2009

Related U.S. Application Data
(62) Division of application No. 10/544,623, filed on Aug. 5, 2005.

(30) Foreign Application Priority Data
May 27, 2003 (JP) 2003-148811
Feb. 26, 2004 (JP) 2004-051849

(51) Int. Cl. B05C 13/02

(52) U.S. Cl. 118/668

(57) ABSTRACT

A plating apparatus has an ashing unit (300) configured to perform an ashing process on a resist (502) applied on a surface of a seed layer (500) formed on a substrate (W), and a pre-wetting section (26) configured to provide hydrophilicity to a surface of the substrate after the ashing process. The plating apparatus includes a pre-soaking section (28) configured to bring the surface of the substrate into contact with a treatment solution to clean or activate a surface of the seed layer formed on the substrate. The plating apparatus also includes a plating unit (34) configured to bring the surface of the substrate into a plating solution in a plating tank while the resist is used as a mask so as to form a plated film (504) on the surface of the seed layer formed on the substrate.

### TECHNICAL FIELD

The present invention relates to a plating apparatus and a plating method for plating a surface of a substrate, and more particularly to a plating apparatus and a plating method for forming a bump (protruding electrode), which provides electrical connection with an electrode of a package or a semiconductor chip, on a surface of a semiconductor wafer while a resist is used as a mask.

### BACKGROUND ART

In tape automated bonding (TAB) or flip chip, for example, it has widely been practiced to form protruding connecting electrodes (bumps) of gold, copper, solder, or nickel, or a multi-layer laminate of these metals at predetermined portions (electrodes) on a surface of a semiconductor chip having interconnects formed therein, and to electrically connect the interconnects via bumps with electrodes of a package or with TAB electrodes. In order to form bumps, there have been used various methods including electroplating, vapor deposition, printing, and ball bumping. In view of a recent increase in the number of I/O terminals in a semiconductor chip and a trend toward finer pitches, an electroplating process has more frequently been employed because the electroplating process can achieve fine processing and has relatively stable performance.

In an electroplating process, bumps are formed at predetermined positions of a surface of a substrate having interconnections in the following manner. In such a process, a resist has been widely used as a mask. First, as shown in FIG. 1A, a seed layer 500 is deposited as a feeding layer on a surface of a substrate W by sputtering or vapor deposition. Then, a resist 502 is applied onto an overall surface of the seed layer 500 so as to have a height H of, for example, 20 to 120 μm. Thereafter, exposure and development are performed on a surface of the resist 502 to form openings 502a having a diameter D of about 20 to about 200 μm at predetermined positions in the resist 502. Then, as shown in FIG. 1B, a metal such as Au or Cu, which is a material for bumps, is deposited in the openings 502a by an electroplating process so as to form and grow plated films 504 in the openings 502a. As shown in FIG. 1C, the resist 502 is stripped and removed from the surface of the substrate W. Then, as shown in FIG. 1D, unnecessary portions of the seed layer 500 are etched and removed from the surface of the substrate W. Then, a reflowing process is performed, as needed, to form spherical bumps 506 as shown in FIG. 1E.

Electroplating processes can be grouped into a jet-type or cup-type electroplating process, in which a plating solution is ejected upward to a substrate such as a semiconductor wafer positioned horizontally in a state such that a surface of the substrate to be plated faces downward, and a dipping-type electroplating process, in which a substrate is immersed vertically in a plating solution within a plating tank while the plating solution is supplied from the bottom of the plating tank so as to overflow the plating tank. According to the dipping-type electroplating process, bubbles which would adversely affect qualities of plated substrates are readily removed, and the footprint of a plating apparatus can be reduced. Further, the dipping-type electroplating process can be readily adapted to variations in wafer size. Thus, the dipping-type electroplating process is considered to be suitable for a bump formation process, which fills relatively large holes and requires a considerably long period of time to complete a plating process.

When plated films are formed in openings in a resist to form bumps on a surface of a substrate such as a semiconductor wafer, because a resist is generally made of a hydrophobic material having low wettability, a plating solution is unlikely to enter the openings in the resist. Accordingly, as shown by an imaginary line in FIG. 1A, air bubbles 508 may be produced in a plating solution. Such air bubbles 508 tend to remain within the openings 502a to cause plating defects such as insufficient plating.

In order to prevent such plating defects, a surface-active agent may be added to a plating solution to lower surface tension of the plating solution so as to readily introduce the plating solution into the openings in the resist. However, when the surface tension of the plating solution is lowered, air bubbles are likely to be produced in the plating solution when the plating solution is circulated. Further, when a new surface-active agent is added to a plating solution, anomaly of deposition may occur so as to increase the amount of organic substances trapped in the plated films. Thus, a surface-active agent may adversely affect properties of the plated films.

With a conventional electroplating apparatus using a dipping-type electroplating process, air bubbles are likely to be released from the openings in the resist. Such an electroplating apparatus employs a substrate holder which holds a substrate such as a semiconductor wafer in a state such that a (front) surface of the substrate to be plated is exposed while sealing a peripheral edge and a rear face of the substrate. The substrate holder is immersed in a plating solution together with the substrate to plate the surface of the substrate. Thus, according to a conventional electroplating apparatus using a dipping-type electroplating process, it is difficult to automate an entire plating process from loading of a substrate to unloading of the substrate after a plating process.

Further, a conventional plating apparatus for bump formation generally has a plating section for performing a plating process, an additional process section for performing additional processes incidental to the plating process, such as a cleaning process and a pre-treatment process, and a transfer robot for transferring a substrate between the plating section and the additional process section. Openings are formed at predetermined positions in a resist on a substrate. Substrates are housed in a substrate cassette. One of the substrates is picked out from the substrate cassette. Then, a metal such as Au or Cu, which is a material for bumps, is deposited and grown in the openings of the resist on the substrate. Thereafter, the substrate is subjected to a post-treatment process such as a cleaning and drying process and returned to the substrate cassette.

Substrates which have been plated by the plating apparatus and returned to the substrate cassette are transferred to a subsequent resist stripping unit, etching unit, or the like while the substrates are housed in the substrate cassette. In the resist stripping unit, the resist is stripped and removed from the surface of the substrate. In the etching unit, unnecessary portions of the seed layer are removed from the surface of the substrate.

However, the conventional plating apparatus for bump formation is designed to perform processes until a plating process, but not to perform processes after the plating process, in consideration of manufacturing lead-time suitable for mass production of a limited variety of goods. Accordingly, the conventional plating apparatus for bump formation cannot continuously perform a sequence of processes to complete bump formation. Further, the conventional plating apparatus for bump formation requires a large space for additional process units such as a resist stripping unit and an etching unit and has less flexibility in arrangement.

### DISCLOSURE OF INVENTION

The present invention has been made in view of the above drawbacks. It is, therefore, a first object of the present invention to provide a plating apparatus and a plating method which can introduce a plating solution reliably into an opening in a resist applied on a surface of a substrate without adding any surface-active agent in a plating solution and can achieve a plating process without any plating defects such as insufficient plating.

A second object of the present invention is to provide a plating apparatus and a plating method which can automatically form a plated film suitable for a protruding electrode such as a bump with a dipping-type process, which can readily release air bubbles.

A third object of the present invention is to provide a plating apparatus which can continuously perform processes including a plating process such as a bump formation process, can reduce a space for the whole apparatus, and is suitable for limited production of a wide variety of goods.

According to a first aspect of the present invention, there is provided a plating apparatus having an ashing unit configured to perform an ashing process on a resist applied on a surface of a seed layer formed on a substrate, and a pre-wetting section configured to provide hydrophilicity to a surface of the substrate after the ashing process. The plating apparatus includes a pre-soaking section configured to bring the surface of the substrate into contact with a treatment solution to clean or activate a surface of the seed layer formed on the substrate. The plating apparatus also includes a plating unit configured to bring the surface of the substrate into a plating solution in a plating tank while the resist is used as a mask so as to form a plated film on the surface of the seed layer formed on the substrate.

When a substrate is plated while a resist is used as a mask, because the resist makes a surface of the substrate hydrophobic, the surface of the substrate is unlikely to be brought into contact with a plating solution to thus cause plating defects such as insufficient plating. The ashing unit performs an ashing process on the resist applied on the surface of the substrate prior to the plating process. The ashing process can reform a hydrophobic surface of the resist into a hydrophilic surface. Thus, the surface of the substrate becomes likely to be brought into contact with a plating solution. Further, a hydrophilic process may be performed on the surface of the substrate in the pre-wetting section after the ashing process to replace a gas in the openings formed in the resist with water and further replace the water with a plating solution. Thus, it is possible to prevent plating defects such as insufficient plating.

The ashing unit may be configured to apply at least one of plasma, light, and an electromagnetic wave to the resist to perform the ashing process on the resist. When the ashing unit is configured to apply high-energy light or electromagnetic waves including plasma, ultraviolet rays, and far ultraviolet rays, then high-energy ions, photons, or electrons collide with the resist to produce an active gas. The ions, photons, or electrons and the active gas can decompose and remove organic substances such as resist residues. Hydrogen is abstracted from organic substances in the resist, or principal chains or side chains of organic substances in the resist 502 are cut, to thereby remove contaminants from the surface of the substrate and reform the surface of the substrate. The ashing unit may be provided inside or outside of a frame of the plating apparatus.

The pre-wetting section may comprise a pre-wetting tank configured to immerse a substrate in pure water or a pre-wetting device configured to eject pure water through a spray to a surface of the substrate. The pre-wetting section may be substantially under vacuum or under a pressure lower than an atmospheric pressure. The pre-wetting section may comprise a deaeration device for deaerating the pure water.

The pre-wetting section may comprise a plurality of pre-wetting portions having different functions. For example, the plating apparatus may include a dipping-type pre-wetting portion using deaerated water, a spray-type pre-wetting section, and the like. In such a case, a suitable pre-wetting portion can be selected according to a recipe. With this arrangement, limitation on processes due to types of pre-wetting sections can be eliminated, and the plating apparatus can perform various types of processes.

The pre-soaking section may comprise a pre-soaking tank to hold the treatment solution including at least one of ozone water, an acid solution, an alkali solution, an acid degreasing agent, a solution containing a developer, a solution containing a resist stripping solution, and reduced water of an electrolytic solution. For example, when the surface of the substrate is brought into contact with a treatment solution (acid solution) such as a sulfuric acid or hydrochloric acid solution, an oxide film, which has a high electrical resistance, formed on a surface of a seed layer can be etched to remove the oxide film and expose a clean metal surface of the seed layer. Further, a substrate may be treated with ozone water and then treated with an acid solution.

Alternatively, the pre-soaking section may comprise a pre-soaking tank to hold the treatment solution including an acid solution or an acid degreasing agent so as to perform an electrolytic process on the substrate in the treatment solution in a state such that the substrate serves as a cathode.

The plating unit may comprise an anode disposed in the plating solution and an anode weight measuring device operable to measure weight of the anode. The anode weight measuring device may comprise a load cell. With this arrangement, consumption of the anode can be measured more accurately than in a case where the weight of the anode has heretofore been estimated indirectly based on the amount of current supplied to the anode. Therefore, it is possible to accurately determine when the anode should be replaced. The weight of the anode can be measured even during a plating process. Thus, even during a continuous plating process, it is possible to accurately determine when the anode should be replaced. Accordingly, the plating apparatus can be operated premeditatedly.

The plating tank may comprise an anode disposed in the plating solution, a dummy anode provided in the plating tank, and a single power supply configured to apply a voltage selectively to the anode for an actual plating process and to the dummy anode for a dummy plating process. Generally, a power supply which is used for dummy plating at the time of replacement of a plating solution is not used during a plating process. Thus, a power supply for dummy plating is not used for a long term and is provided uneconomically. With the above arrangement, a single power supply can be switched so as to perform a dummy plating process and an actual plating process. Thus, a separate power supply for dummy plating can be eliminated, and the number of power supplies can be reduced. The single power supply may be configured to automatically switch application of the voltage so as to perform the actual plating process after completion of the dummy plating process.

The plating apparatus may include a plating solution management unit configured to manage components of the plating solution to be supplied to the plating unit. The plating solution management unit can automatically perform analysis of components in the plating solution and addition of components which have been insufficient to the plating solution, which have heretofore been performed by hand. Thus, the plating solution management unit can maintain each component in the plating solution within a predetermined range. Since a plating process is performed with a plating solution thus managed, it is possible to maintain good properties (components), good appearance, and good uniformity of the thickness of a plated film formed on the substrate. The plating solution management unit may be provided inside or outside of the frame of the plating apparatus.

The plating solution management unit may be configured to analyze and/or estimate components of the plating solution and to add an insufficient component to the plating solution through a feedback control and/or a feedforward control. For example, the plating solution management unit extracts a portion of the plating solution as a sample from the plating tank and analyzes it. Components which have been insufficient for a predetermined amount are added into the plating solution through a feedback control based on the analysis by the plating solution management unit, a feedforward control estimating disturbances including the plating time or the number of plated substrates, or a combination of the feedback control and the feedforward control. Thus, each component in the plating solution can be maintained within a predetermined range.

The plating apparatus may include a communication device configured to communicate information through a communication network using a computer. The communication device can transmits information on, for example, plating results to proper units or devices through the communication network using the computer. Thus, required information is mutually transmitted through the communication device so as to control the units or devices based on the information to achieve a fully automatic plating process. The communication device may be provided inside or outside of the frame of the plating apparatus.

The plating apparatus may include a resist stripping unit configured to strip and remove the resist used as a mask from the surface of the seed layer formed on the substrate. The resist stripping unit may be provided inside or outside of the frame of the plating apparatus. From a viewpoint of continuous processing, it is desirable that the resist stripping unit should strip a resist on a substrate while the substrate is held by a substrate holder. The substrate after stripping the resist may be returned to a substrate cassette.

The plating apparatus may include a seed layer removal unit configured to remove an unnecessary portion of a seed layer formed on the substrate. The seed layer removal unit may be provided inside or outside of the frame of the plating apparatus. From a viewpoint of continuous processing, it is desirable that the seed layer removal unit should remove an unnecessary portion of a seed layer on a substrate while the substrate is held by a substrate holder. The substrate after removing the seed layer may be returned to a substrate cassette.

The plating apparatus may include an annealing unit configured to anneal the plated film formed on the surface of the substrate. The annealing unit may be provided inside or outside of the frame of the plating apparatus.

The plating apparatus may include a reflowing unit configured to reflow the plated film formed on the surface of the substrate. The reflowing unit may be provided inside or outside of the frame of the plating apparatus.

The plating apparatus may include a neutralization unit configured to perform a neutralization treatment on the surface of the substrate. After the substrate has been plated and cleaned, acid or alkali components contained in the plating solution may remain on the substrate. With the neutralization unit, since neutralization treatment is performed on the substrate after the plating process, it is possible to eliminate adverse influence on the resist stripping process and the seed layer removal process, which are performed after the plating process, from acid or alkali. For example, the neutralization treatment solution may comprise an alkalescent solution containing trisodium phosphate. The neutralization unit may be provided inside or outside of the frame of the plating apparatus.

The plating apparatus may include a visual inspection unit configured to inspect an appearance of the plated film formed on the surface of the substrate. Some substrate may have a defective appearance of a plated film for various reasons including anomaly of a plating solution, a substrate, and a plating apparatus. If a plating process is continued without halting the plating apparatus when a defective substrate is produced, then the number of defective substrates is increased. The visual inspection unit performs visual inspection of the plated film and notifies an operator when the plated film has a defective appearance. At that time, the plating apparatus is halted, and the defective substrate is recorded in substrate processing data. Thus, the number of defective substrates can be reduced, and the defective substrates can be removed based on the substrate processing data. The visual inspection unit may be provided inside or outside of the frame of the plating apparatus. The visual inspection unit may be configured to inspect the appearance of the plated film in a contact or non-contact manner.

The plating apparatus may include a film thickness measurement unit configured to measure film thickness of the plated film formed on the surface of the substrate. The film thickness of a plated film formed on a substrate may vary according to influence from patterns formed on a substrate and conditions of the apparatus, the plating solution, and the substrate. In some cases, the within wafer uniformity of the film thickness of the plated film may excessively be lowered so as not to meet the specification limits. If the plating apparatus is operated to plate substrates continuously, then the number of defective substrate may be increased. Even if the within wafer uniformity of the film thickness is within the specification limits, a subsequent polishing process may be required according to the plating process. In such a case, it is necessary to set the amount of polishing to be required. The film thickness measurement unit may be configured to measure a distribution of the film thickness of the plated film formed on the substrate over an overall surface of the substrate. Based on the measurement results, the film thickness measurement unit determines whether or not the substrate has good quality. If the substrate does not have good quality, the substrate is recorded in substrate processing data. Based on a rate of defective substrates recorded in the substrate processing data, the plating apparatus is halted, and an operator is notified of the anomaly. Thus, defective substrates, which have a low within wafer uniformity of the film thickness of the plated film, can be removed, and the required amount of the plated film to be polished can be set in a case where there is a polishing process as a subsequent process. The film thickness measurement unit may be provided inside or outside of the frame of the plating apparatus. The film thickness measurement unit may be configured to measure the film thickness of the plated film in a contact or non-contact manner.

The plating apparatus may include a plating area measurement unit configured to measure an actual area in which the plated film is to be formed on the surface of the substrate. A plating area is required to determine plating conditions. However, a plating area cannot be known or otherwise cannot accurately be known in some cases. The plating area measurement unit can measure an actual area (plating area) in which a plated film is to be formed. Thus, a current value which determines plating conditions can be accurately determined. Accordingly, it is possible to accurately obtain a plated film having a predetermined film thickness in a predetermined plating time. In particular, in a case where a single substrate is plated at a time, substrates having different plating areas can be plated so as to have a predetermined film thickness merely by setting a current density and a plating period of time. Accordingly, setting of recipes is greatly facilitated.

The plating area measurement unit may be provided inside or outside of the frame of the plating apparatus. The plating area measurement unit may be configured to supply a current to the substrate to measure the actual area. The plating area measurement unit may be configured to optically scan the surface of the substrate to measure the actual area. For example, when a substrate is sealed at a peripheral portion and detachably held by a substrate holder in a state such that a surface of a substrate to be plated is exposed externally, the surface of the substrate is optically scanned to measure a plating area.

The plating apparatus may include a polishing unit configured to polish a surface of the plated film to adjust film thickness of the plated film. The polishing unit may be provided inside or outside of the frame of the plating apparatus. The polishing unit may be configured to perform chemical mechanical polishing or mechanical polishing to polish the surface of the plated film.

The plating apparatus may include a chemical liquid adjustment unit configured to remove metal impurities or organic impurities mixed in the plating solution or generated decomposition products. In order to maintain evaluation properties of a deposited film, a plating solution used in a plating process should be renewed periodically according to levels of impurities mixed in the plating solution or accumulated decomposition products. An old plating solution is discarded except for particular plating solutions such as a gold plating solution, thereby causing loads on cost and environment. The chemical liquid adjustment unit can remove impurities and decomposition products contained in an old plating solution so as to lengthen a frequency of renewal of a plating solution. Thus, it is possible to reduce loads on cost and environment. The chemical liquid adjustment unit may be provided inside or outside of the frame of the plating apparatus. The chemical liquid adjustment unit may include at least one of an electrolytic process section, an ion exchange section, an activated carbon process section, and a coagulation and settlement section.

The plating apparatus may include a chemical liquid supply and recovery unit configured to supply a chemical liquid to the plating tank and recover the chemical liquid from the plating tank. With the chemical liquid supply and recovery unit, a highly corrosive or harmful chemical liquid which would exert an adverse influence not only on the apparatus or units but also on human bodies can readily be handled with safe because operators are not required to handle the chemical liquid so often. The chemical liquid supply and recovery unit may be provided inside or outside of the frame of the plating apparatus.

The chemical liquid supply and recovery unit may include a chemical liquid container attached in a replaceable manner. The chemical liquid supply and recovery unit is configured to supply the chemical liquid from the chemical liquid container to the plating tank and to recover the chemical liquid from the plating tank to the chemical liquid container. A commercially available chemical liquid tank or bottle may be used as a chemical liquid container and attached in a replaceable manner. Thus, a chemical liquid is supplied directly from the available chemical liquid tank or bottle to the plating tank and recovered from the plating tank directly to the available chemical liquid tank or bottle. When the chemical liquid tank or bottle becomes empty at the time of supply of the chemical liquid, an operator is notified of a signal indicating that the chemical liquid tank or bottle should be replenished or replaced with a filled chemical liquid tank or bottle. At that time, the supply of the chemical liquid is interrupted. After the chemical liquid tank or bottle has been replenished or replaced with a filled chemical liquid tank or bottle, the supply of the chemical liquid is restarted. When the chemical liquid tank or bottle becomes full at the time of recovery of the chemical liquid, an operator is notified of a signal indicating that the chemical liquid tank or bottle should be replaced with an empty chemical liquid tank or bottle or the chemical liquid should be discharged from the chemical liquid tank or bottle. At that time, the recovery of the chemical liquid is interrupted. After the chemical liquid tank or bottle has been replaced with an empty chemical liquid tank or bottle or become empty, the recovery of the chemical liquid is restarted.

The plating apparatus may include a plating solution regeneration unit configured to remove an organic substance contained in the plating solution to regenerate the plating solution. During the plating process, for example, a plating solution in which a component ratio of an additive such as an organic component or a surface-active agent is excessively increased beyond a predetermined range, or a plating solution in which an additive or a surface-active agent is decomposed but remains as a waste product can be regenerated by the plating solution regeneration unit without replacement of the plating solution, so that cost and work for replacement with a new plating solution can remarkably be reduced. Particularly, together with use of the plating solution management unit, a plating solution can be regenerated to substantially the same degree as a new plating solution. The plating solution regeneration unit may be provided inside or outside of the frame of the plating apparatus.

The plating solution regeneration unit may be configured to remove the organic substance through an activated carbon filter. The plating apparatus may have a plating solution circulation system for flowing the plating solution through the plating solution regeneration unit, which includes a replaceable activated carbon filter, and the plating tank. With such a plating solution circulation system, the plating solution flows through the activated carbon filter in the plating solution regeneration unit to remove an organic substance as an additive in the plating solution and a waste product into which the organic substance is decomposed. Thus, a plating solution from which an additive component (organic substance) is removed can be returned to the plating tank.

The plating apparatus may include an exhaust gas treatment unit configured to remove a harmful component from gas or mist produced in the plating apparatus and to discharge harmless gas to an exterior of the plating apparatus through a duct. Generally, gas or mist produced in a plating apparatus is harmful to other apparatuses or facilities. An exhaust duct from a plating apparatus is generally connected and joined to a collective exhaust duct. Accordingly, an exhaust gas which has not been treated in the plating apparatus may react with an exhaust gas from other apparatuses so as to exert an adverse influence on other apparatuses or facilities. The exhaust gas treatment unit can remove harmful gas and mist from an exhaust gas and introduce the exhaust gas into a collective exhaust duct to prevent an adverse influence on other apparatuses or facilities. Thus, it is possible to reduce loads on removing harmful components in other apparatuses or facilities. The exhaust gas treatment unit may be provided inside or outside of the frame of the plating apparatus.

The exhaust gas treatment unit may be configured to remove the harmful component through a wet process with an absorption liquid, a dry process with an absorbent, or a condensation liquefaction process by cooling. The plating tank may have a first chamber holding an acid plating solution, a second chamber holding a cyanic plating solution, and a partition to separate the first chamber and the second chamber. The first chamber may include an exhaust duct to discharge an acid gas produced from the acid plating solution in the first chamber. The second chamber may include an exhaust duct to discharge a cyanic gas produced from the cyanic plating solution in the second chamber. For example, if a plating process with an acid plating solution and a plating process with a cyanic plating solution are performed in the same plating apparatus, then the plating solutions or gas may be mixed to produce a cyanic gas. In order to prevent such a drawback, these processes have heretofore been performed in separate plating apparatuses. With the above arrangement, an acid gas produced from an acid plating solution and a cyanic gas produced from a cyanic plating solution can separately be discharged so as to prevent the plating solutions or gas from being mixed to produce a cyanic gas. Thus, a plating process with an acid plating solution and a plating process with a cyanic plating solution can be performed continuously in the same plating apparatus. The cyanic plating solution may comprise a gold plating solution or a silver plating solution.

The plating apparatus may include a waste water regeneration unit configured to regenerate waste water, which has been used in and discharged from the plating unit, to reuse at least a portion of regenerated waste water for the plating process while discharging the rest of the waste water to an exterior of the plating apparatus. A cleaning process in the plating process requires a large amount of cleaning water. A large amount of cleaning water having high cleanliness and treatment of waste water which has been used in the plating process impose large loads on existing facilities. With the waste water regeneration unit, the plating apparatus has a completely or partially closed system for regenerating waste water used therein. Thus, it is possible to reduce the amount of cleaning water having high cleanliness and loads on waste water treatment required for the facilities. The waste water regeneration unit may be provided inside or outside of the frame of the plating apparatus.

The waste water regeneration unit may be configured to regenerate the waste water by at least one of microfiltration, ultraviolet irradiation, ion exchange, ultrafiltration, and reverse osmosis. A portion or all of cleaning water used in the plating unit can be stored in a tank of the waste water regeneration unit and recovered therein. Then, a portion or all of the regenerated water can be used as cleaning water, and the rest of the regenerated water can be discharged to the facilities or water tank.

According to a second aspect of the present invention, there is provided a plating apparatus having a loading/unloading section configured to load and unload a cassette housing substrates, a sensor provided in the loading/unloading section for detecting sizes of the substrates received in the cassette, and a plurality of tools corresponding to sizes of substrates to be plated. The plating apparatus includes a tool stocker to store the plurality of tools and a plating section configured to perform at least a plating process. The plating apparatus also includes a controller configured to select a tool corresponding to a size detected by the sensor from the plurality of tools, and a transfer device configured to hold and transfer the tool selected by the controller to the plating section.

If a plating apparatus is designed so as to correspond to the size of a substrate to be plated, then a plurality of plating apparatuses are required to correspond various sizes of substrates. Accordingly, a large space for installation and utilities such as a power supply are required in a clean room. With the above arrangement, a single plating apparatus can perform a plating process on substrates having different sizes, so that a required space in a clean room, which is expensive, required energy, and required cost can be reduced while substrates having different sizes are plated.

According to a third aspect of the present invention, there is provided a plating apparatus having a plurality of plating tanks each having a plating solution and an anode therein. The plating apparatus includes a single power supply configured to selectively apply a voltage between a substrate and anodes in the plurality of plating tanks so as to perform sequential plating processes.

Thus, the use of the single plating power supply can reduce the number of plating power supplies. Accordingly, the plating apparatus can be made compact in size. Further, when troubles occur in the plating power supply, the plating process can be interrupted before a substrate has been plated or while a substrate is plated. Accordingly, it is not necessary to discard the substrate, and the substrate can be plated by the plating power supply that has been repaired.

The plurality of plating tanks may contain different kinds of metals. The plating apparatus may include a sensor for detecting when a substrate is immersed in the plating solutions of the plurality of plating tanks, and a switch operable to switch the single power supply based on a signal from the sensor.

According to a fourth aspect of the present invention, there is provided a plating method to form a plated film on a surface of a substrate. A resist is applied on a surface of a seed layer formed on the substrate. After an ashing process of the resist, a hydrophilic process is performed on the surface of the substrate to provide hydrophilicity to the surface of the substrate. After the hydrophilic process, the surface of the substrate is cleaned or activated. The surface of the substrate is brought into a plating solution while the resist is used as a mask so as to perform a plating process to form a plated film on the surface of the substrate.

The hydrophilic process may comprise continuously performing two or more types of hydrophilic processes. The resist may be stripped and removed from the surface of the substrate after the plating process. An unnecessary portion of a seed layer formed on the surface of the substrate may be removed. The plated film formed on the surface of the substrate may be annealed. The plated film formed on the surface of the substrate may be reflowed. A neutralization treatment may be performed on the surface of the substrate after the plating process. An appearance of the plated film formed on the surface of the substrate may be inspected. Film thickness of the plated film formed on the surface of the substrate may be measured. An actual area in which the plated film is to be formed on the surface of the substrate may be measured. The plated film formed on the surface of the substrate may be polished to adjust film thickness of the plated film.

With the above arrangement, a plating solution can be introduced reliably into an opening of the resist on the surface of the substrate without adding any surface-active agent, so that a plating process without any plating defects such as insufficient plating can be achieved. Further, a plated film suitable for a protruding electrode such as a bump can be automatically formed with a dipping-type process, which can readily release air bubbles.

According to a fifth aspect of the present invention, there is provided a plating apparatus having a plating unit configured to form a plated film on a surface of a substrate while a resist is applied as a mask on a surface of a seed layer formed on a substrate. The plating apparatus includes a resist stripping unit configured to strip and remove the resist from the surface of the seed layer, and an etching unit configured to remove an unnecessary portion of the seed layer formed on the surface of the substrate. The plating unit, the resist stripping unit, and the etching unit are incorporated integrally with each other.

Since the plating unit, the resist stripping unit, and the etching unit are incorporated integrally with each other, a plating process, a resist removal process, and a seed layer removal process can be performed continuously. Further, the plating apparatus can flexibly perform a desired plating process.

The plating apparatus may include a cleaning unit configured to clean the substrate and a pre-treatment unit configured to perform a pre-treatment process before plating. The plating apparatus may include a reflowing unit configured to reflow the plated film formed on the surface of the substrate. The plated film may form a bump.

With the above arrangement, a bump formation process including a plating process can be performed continuously so as to reduce a space for the apparatus. Further, the plating apparatus can achieve a desired plating process suitable for limited production of a wide variety of goods.

The above and other objects, features, and advantages of the present invention will be apparent from the following description when taken in conjunction with the accompanying drawings which illustrate preferred embodiments of the present invention by way of example.

### BRIEF DESCRIPTION OF DRAWINGS

FIGS. 1A through 1E are cross-sectional views showing a process of forming a bump (protruding electrode) on a substrate;

FIG. 2 is a schematic plan view showing a plating section in a plating apparatus according to a first embodiment of the present invention;

FIG. 3 is a plan view showing a substrate holder in the plating section shown in FIG. 2;

FIG. 4 is an enlarged cross-sectional view of a plating unit in the plating section shown in FIG. 2;

FIG. 5 is a plan view showing the plating apparatus including the plating section shown in FIG. 2 and other various units;

FIG. 6 is a flow chart showing a process before a substrate is removed from the substrate holder in the plating apparatus shown in FIG. 5;

FIG. 7 is a flow chart showing a process after the substrate is removed from the substrate holder in the plating apparatus shown in FIG. 5;

FIG. 8 is a schematic plan view showing a plating apparatus according to a second embodiment of the present invention; and

FIG. 9 is a schematic plan view showing a plating apparatus according to a third embodiment of the present invention.

### DETAILED DESCRIPTION OF THE INVENTION

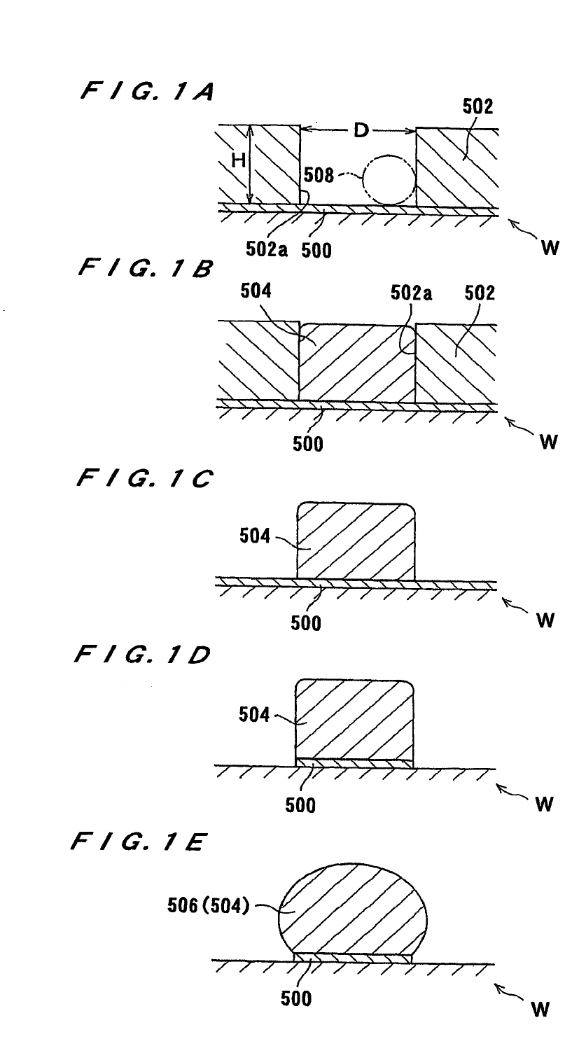

A plating apparatus according to embodiments of the present invention will be described below with reference to FIGS. 1A through 9. Like or corresponding parts are denoted by like or corresponding reference numerals throughout drawings, and will not be described below repetitively.

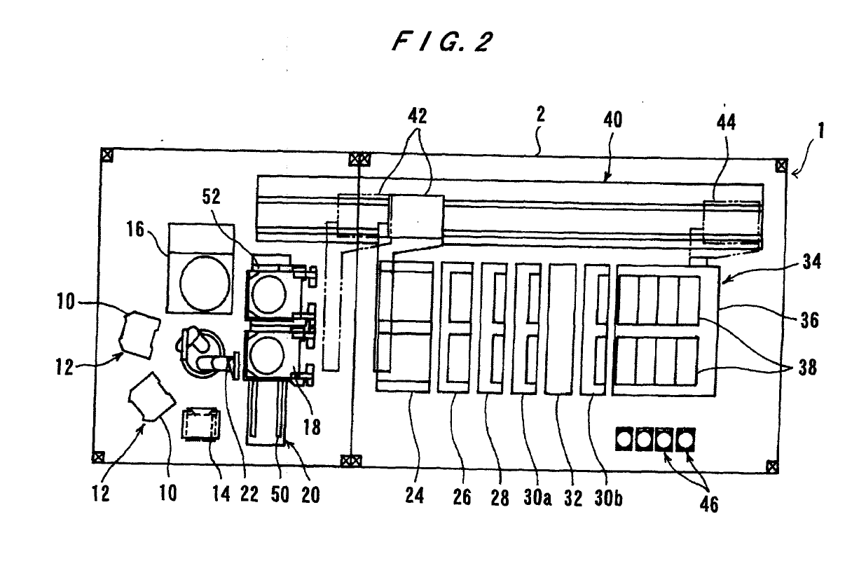

FIG. 2 is a schematic plan view showing a plating section 1 in a plating apparatus according to a first embodiment of the present invention. As shown in FIG. 2, the plating section 1 has a rectangular frame 2, two cassette tables 12 each for placing thereon a cassette 10 which houses substrates such as semiconductor wafers, an aligner 14 for aligning an orientation flat or a notch of a substrate in a predetermined direction, and a cleaning and drying device 16 for cleaning a plated substrate and rotating the substrate at a high speed to dry the substrate. The cassette tables 12, the aligner 14, and the cleaning and drying device 16 are disposed along the same circle in the frame 2. The plating section 1 includes a substrate loading/unloading unit 20 disposed along a tangent line to the circle for loading a substrate onto and unloading a substrate from a substrate holder 18. The plating section 1 also has a substrate transfer device (transfer robot) 22 disposed at the center of the circle for transferring a substrate between the cassette tables 12, the aligner 14, the cleaning and drying device 16, and the substrate loading/unloading unit 20.

The plating section 1 has a stocker 24 for storing or temporarily receiving substrate holders 18, a pre-wetting tank (pre-wetting section) 26, a pre-soaking tank (pre-soaking section) 28, a first cleaning tank 30a for cleaning a surface of the substrate with pure water, a blowing tank 32 for removing water from a cleaned substrate, a second cleaning tank 30b for cleaning a surface of the substrate, and a plating tank 34. The stocker 24, the pre-wetting tank 26, the pre-soaking tank 28, the first cleaning tank 30a, the blowing tank 32, the second cleaning tank 30b, and the plating tank 34 are arranged in order from the substrate loading/unloading unit 20 in the frame 2. The pre-wetting tank 26 is configured to immerse a substrate in pure water to provide hydrophilicity to a surface of the substrate. For example, the pre-soaking tank 28 is configured to etch an oxide film, which has a high electrical resistance, formed on a surface of a seed layer with a treatment solution such as a sulfuric acid or hydrochloric acid solution to remove the oxide film and clean or activate a surface of an exposed seed layer. The plating tank 34 has an overflow tank 36 and a plurality of plating units 38 disposed within the overflow tank 36. Each of the plating units 38 is configured to hold one substrate therein to plate the substrate with copper. In the present embodiment, a copper plating process is performed on substrates in the plating tanks 34. However, the present invention is also applicable to nickel, solder, or gold plating.

In the present embodiment, the pre-wetting section comprises a pre-wetting tank 26 for immersing a substrate in pure water. However, the pre-wetting section may comprise a pre-wetting device for ejecting pure water through a spray to a surface of a substrate. The pre-wetting section is preferably substantially under vacuum or under a pressure lower than an atmospheric pressure. Alternatively, pure water to be supplied to the pre-wetting section may be deaerated by a deaeration device.

Further, the plating section 1 has one pre-wetting tank (pre-wetting section) 26 in the illustrated example. However, the plating section 1 may have a plurality of pre-wetting portions having different arrangements. Specifically, the plating section 1 may have a plurality of pre-wetting portions including a dipping-type pre-wetting portion using deaerated water as described above, a spray-type pre-wetting portion, and the like. In such a case, a suitable pre-wetting portion can be selected according to a recipe. With this arrangement, limitations on processes due to types of pre-wetting sections can be eliminated, and the plating apparatus can perform various types of processes.

The pre-soaking tank 28 is supplied with an acid solution such as a sulfuric acid or hydrochloric acid solution, ozone water, an alkali solution, an acid degreasing agent, a solution containing a developer, a solution containing a resist stripping solution, reduced water of an electrolytic solution, or the like. Type of solution to be used is selected according to purposes of plating. Further, a substrate may be treated with ozone water and then treated with an acid solution. Alternatively, an electrolytic process may be performed on a substrate in an acid solution or an acid degreasing agent in a state such that the substrate serves as a cathode.

The plating section 1 also has a substrate holder transfer device (substrate transfer device) 40 disposed along the units 20, 24, 26, 28, 30a, 32, 30b, and 34. The substrate holder transfer device 40 transfers substrate holders 18 together with substrates between the units 20, 24, 26, 28, 30a, 32, 30b, and 34. The substrate holder transfer device 40 includes a first transporter 42 for transferring substrate holders 18 between the substrate loading/unloading unit 20 and the stocker 24, and a second transporter 44 for transferring substrate holders 18 between the stocker 24, the pre-wetting tank 26, the pre-soaking tank 28, the cleaning tanks 30a and 30b, the blowing tank 32, and the plating tank 34.

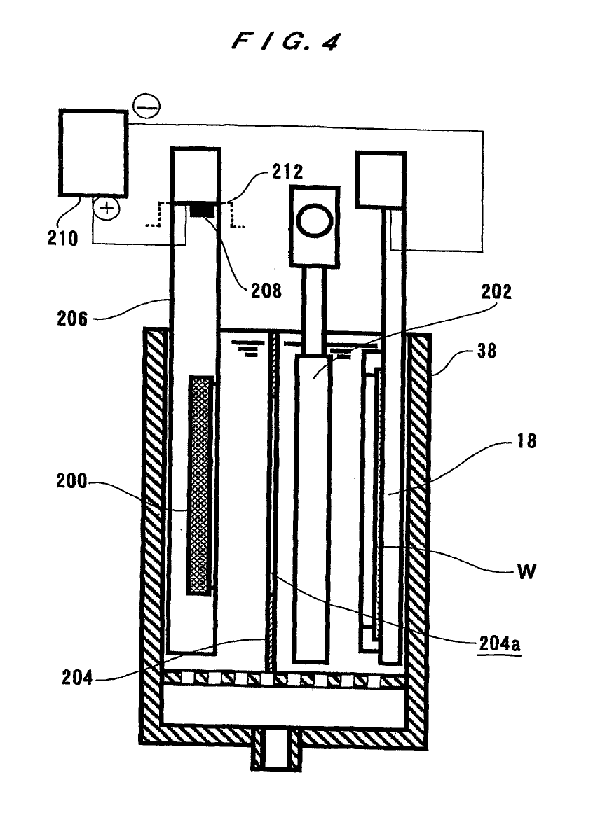

The plating section 1 includes a plurality of paddle driving units 46 on the opposite side of the overflow tank 36 to the substrate holder transfer device 40. Each of the paddle driving units 46 drives a paddle 202 (see FIG. 4) provided in each plating unit 38. The paddle 202 serves as a stirring rod for agitating a plating solution.

The substrate loading/unloading unit 20 has rails 50 and a flat loading plate 52 slidable horizontally along the rails 50. The loading plate 52 supports two substrate holders 18 placed parallel to each other in a horizontal state. A substrate is transferred between one of the substrate holders 18 and the substrate transfer device 22, and then another substrate is transferred between the other of the substrate holders 18 and the substrate transfer device 22.

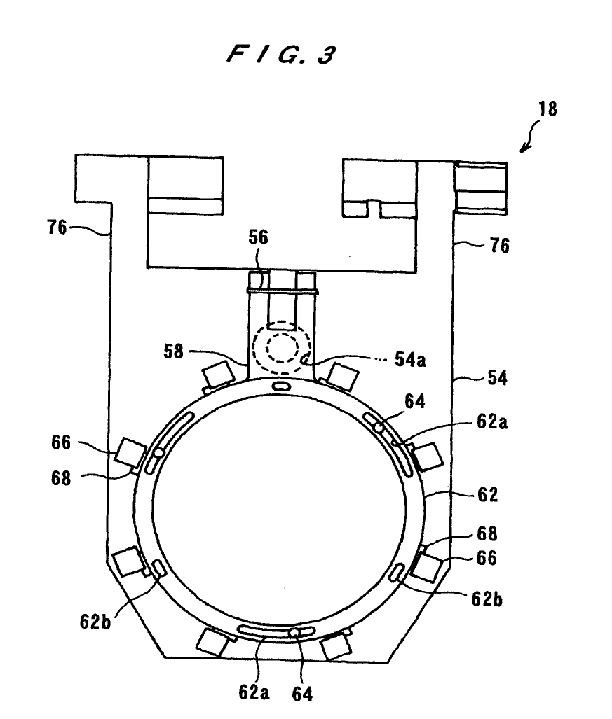

FIG. 3 is a plan view showing the substrate holder 18 shown in FIG. 2. As shown in FIG. 3, each substrate holder 18 has a stationary support member 54 in the form of a flat rectangular plate and a movable support member 58 in the form of a ring. The movable support member 58 is attached to the stationary support member 54 in a state such that it can be opened and closed via a hinge 56. A clamp ring 62 is attached to the movable support member 58 on the opposite side of the movable support member 58 to the stationary support member 54. The clamp ring 62 is supported by bolts 64 extending from the movable support member 58 through elongated holes 62a formed along a circumferential direction in the clamp ring 62. Thus, the clamp ring 62 is configured to be rotatable and not to be detached from the movable support member 58.

The stationary support member 54 has L-shaped pawls 66 positioned near a peripheral portion of the movable support member 58. The pawls 66 are arranged along the circumferential direction at equal intervals. The clamp ring 62 has a plurality of protrusions 68 projecting radially outward. The protrusions 68 are formed integrally with the clamp ring 62 and arranged at equal intervals. The clamp ring 62 also has slightly elongated holes 62b (three holes in FIG. 3) for rotating the protrusions 68. Each protrusion 68 has an upper surface tapered so as to be inclined along a rotating direction. Each pawl 66 has a lower surface tapered so as to be inclined along the rotating direction and opposed to the upper surface of the corresponding protrusion 68.

When the movable support member 58 is in an opened state, a substrate is inserted and positioned properly in a central area of the stationary support member 54. Then, the movable support member 58 is closed via the hinge 56. Subsequently, the clamp ring 62 is rotated clockwise so as to slide the protrusions 68 of the clamp ring 62 into the lower portions of the L-shaped pawls 66. Thus, the movable support member 58 is fastened to and locked in the stationary support member 54. When the clamp ring 62 is rotated counterclockwise, the protrusions 68 of the clamp ring 62 are slid out from the L-shaped pawls 66 to unlock the movable support member 58 from the stationary support member 54.

When the movable support member 58 is locked in the stationary support member 54 as described above, a seal packing (not shown) provided on a surface of the movable support member 58, which faces the stationary support member 54, is pressed against a surface of the substrate so as to provide a reliable seal. Simultaneously, the substrate is brought into electric contact with an external electrode (not shown), which is provided on the stationary support member 54, at a location sealed by the seal packing.

The movable support member 58 is opened and closed by a cylinder (not shown) and the weight of the movable support member 58. Specifically, the stationary support member 54 has a through-hole 54a formed therein. The loading plate 52 has a cylinder provided at a position facing the through-hole 54a when the substrate holder 18 is mounted on the loading plate 52. The movable support member 58 is opened when the movable support member 58 is pushed upward through the through-hole 54a by a cylinder rod (not shown). The movable support member 58 is closed by its own weight when the cylinder rod is retracted.

In the present embodiment, the movable support member 58 is locked and unlocked by rotating the clamp ring 62. The loading plate 52 has a locking/unlocking mechanism provided on a ceiling side. The locking/unlocking mechanism has pins disposed at positions corresponding to the holes 62b in the clamp ring 62 of the substrate holder 18, which is placed on the loading plate 52 and positioned near the center of the loading plate 52. When the loading plate 52 is lifted so as to insert the pins into the holes 62b, the pins are rotated about the center of the clamp ring 62 to thereby rotate the clamp ring 62. The loading plate 52 has only one locking/unlocking mechanism. After one of the two substrate holders 18 placed on the loading plate 52 is locked or unlocked by the locking/unlocking mechanism, the loading plate 52 is slid horizontally to lock or unlock the other of the substrate holders 18.

Each of the substrate holders 18 has a sensor for detecting whether a substrate is brought into contact with contact points when the substrate is loaded into the substrate holder 18. The sensor outputs signals to a controller (not shown). Each of the substrate holders 18 also has a pair of hands 76 provided at ends of the stationary support member 54. The hands 76 have substantially a T-shape and serve as support portions for supporting the substrate holder 18 when the substrate holder 18 is transferred or suspended. Protruding ends of the hands 76 are engaged with peripheral upper walls of the stocker 24 so that the substrate holder 18 is held in a vertically suspended state. The transporter 42 of the substrate holder transfer device 40 grips the hands 76 of the substrate holder 18 held in the vertically suspended state and transfers the substrate holder 18. The protruding ends of the hands 76 are also engaged with peripheral upper walls of the pre-wetting tank 26, the pre-soaking tank 28, the cleaning tanks 30a and 30b, the blowing tank 32, and the plating tank 34 so that the substrate holder 18 is held in a vertically suspended state.

FIG. 4 shows a cross-section of one of the plating units 38. As shown in FIG. 4, the plating unit 38 has an anode 200 and a paddle (stirring rod) 202. The anode 200 is disposed in the plating unit 38 at a position facing a surface of a substrate W when the substrate holder 18 is positioned at a predetermined location. The paddle 202 is disposed substantially vertically in the plating unit 38 between the anode 200 and the substrate W. The paddle 202 is configured to be movable parallel to the substrate W in a reciprocating manner by the paddle driving units 46.

Thus, the paddle 202 is disposed between the substrate W and the anode 200 and reciprocated parallel to the substrate W. Accordingly, a flow of a plating solution can be equalized along the surface of the substrate W to thereby form a uniform plated film over the entire surface of the substrate W.

In the present embodiment, the plating unit 38 also has a regulation plate (mask) 204 having a central hole 204a between the paddle 202 and the anode 200. The size of the central hole 204a corresponds to the size of the substrate W. The regulation plate 204 lowers electric potentials of peripheral portions of the substrate W so as to equalize the thickness of the plated film.

The anode 200 is held by an anode holder 206. The anode holder 206 has an upper end which is held on peripheral upper walls of the plating unit 38 in a suspended state. The plating unit 38 has a suspension portion 212, which is shown by an imaginary line in FIG. 4, provided at the peripheral upper walls of the plating unit 38. A load cell 208 is attached as an anode weight measuring device to the suspension portion 212. The weight of the anode 200 is measured together with the anode holder 206 by the load cell 208.

Thus, the weight of the anode 200 can be measured directly by the load cell 208. Accordingly, consumption of the anode 200 can be measured more accurately than in a case where the weight of the anode 200 has heretofore been estimated indirectly based on the amount of current supplied to the anode 200. Therefore, it is possible to accurately determine when the anode 200 should be replaced. The weight of the anode 200 can be measured even during a plating process. Thus, even during a continuous plating process, it is possible to accurately determine when the anode 200 should be replaced. Accordingly, the plating apparatus can be operated premeditatedly.

The plating unit 38 includes a power supply 210 for applying a voltage between the anode 200 and the substrate W. The anode 200 is connected to an anode of the power supply 210. The seed layer 500 (see FIG. 1A) of the substrate W held by the substrate holder 18 is connected through the substrate holder 18 to a cathode of the power supply 210. The power supply 210 also serves to apply a voltage between a dummy anode (not shown) provided in the plating tank 34 and a cathode so as to perform a dummy plating process, for example, during the time of replacement of a plating solution. Specifically, the power supply 210 applies a voltage between the anode 200 and the seed layer 500 of the substrate W and changes application of the voltage so as to apply a voltage between the dummy anode and the cathode for performing a dummy plating process.

Generally, a power supply which is used for dummy plating at the time of replacement of a plating solution is not used during an actual plating process. Thus, a power supply for dummy plating is not used for a long term and is provided uneconomically. In the present embodiment, a single power supply 210 can be switched so as to perform a dummy plating process and an actual plating process. Thus, a power supply for dummy plating can be eliminated, and the number of power supplies can be reduced.

In order to facilitate switching of the power supply 210, the power supply 210 should preferably be automatically switched so as to perform an actual plating process after completion of the dummy plating process.

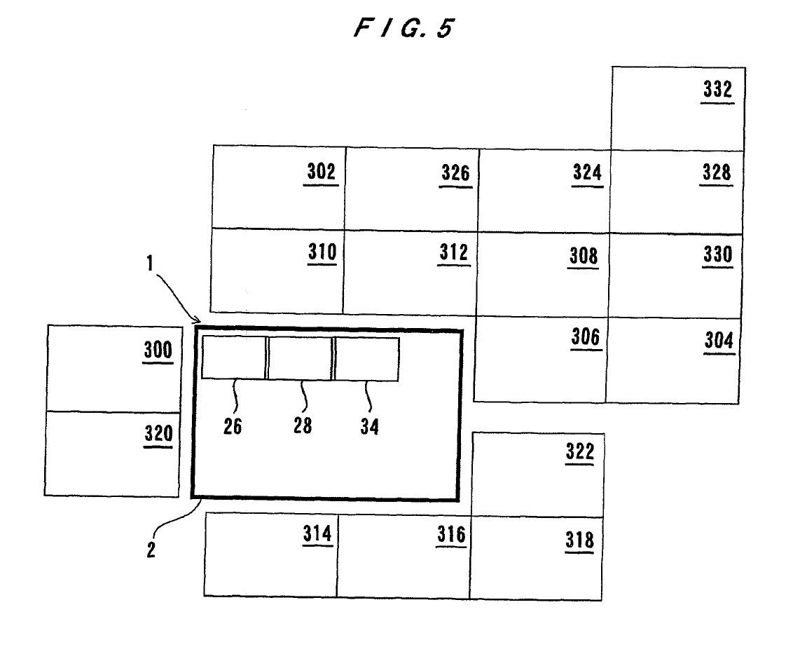

FIG. 5 is a plan view showing a plating apparatus including the plating section 1 shown in FIG. 2 and other various units. Although FIG. 5 shows that the various units are provided outside of the frame 2 of the plating section 1, the various units may be provided within the frame 2 of the plating section 1. A portion or all of the various units may be disposed outside of the frame 2 of the plating section 1.

The plating apparatus includes an ashing unit 300 for performing an ashing process on a resist 502 applied on a surface of a seed layer 500 of a substrate (see FIG. 1A). The ashing unit 300 is configured to apply high-energy light or electromagnetic waves including plasma, ultraviolet rays, and far ultraviolet rays. Accordingly, high-energy ions, photons, or electrons collide with the resist 502 to produce an active gas, which abstracts hydrogen from organic substances in the resist 502 or cuts principal chains or side chains of organic substances in the resist 502. Thus, the ashing unit 300 performs an ashing process on a surface of the resist 502.

When a substrate is plated while a resist is used as a mask, because the resist makes a surface of the substrate hydrophobic, the surface of the substrate is unlikely to be brought into contact with a plating solution to thus cause plating defects such as insufficient plating. In the present embodiment, the ashing unit 300 performs an ashing process on the resist 502 applied on the surface of the substrate prior to the plating process. The ashing process can reform a hydrophobic surface of the resist 502 into a hydrophilic surface. Thus, the surface of the substrate becomes likely to be brought into contact with a plating solution. Further, a hydrophilic process may be performed on the surface of the substrate in the pre-wetting tank 26 after the ashing process to replace a gas in the openings 502a formed in the resist 502 (see FIG. 1A) with water and further replace the water with a plating solution. Thus, it is possible to prevent plating defects such as insufficient plating.

The plating apparatus also includes a plating solution management unit 302 for managing components of a plating solution to be supplied to the plating tank 34. The plating solution management unit 302 extracts a portion of a plating solution as a sample from the plating tank and analyzes it. Components which have been insufficient for a predetermined amount are added into the plating solution through a feedback control based on the analysis by the plating solution management unit 302, a feedforward control estimating disturbances including the plating time or the number of plated substrates, or a combination of the feedback control and the feedforward control. Thus, each component in the plating solution can be maintained within a predetermined range.

The plating solution management unit 302 can automatically perform analysis of components in the plating solution and addition of components which have been insufficient to the plating solution, which have heretofore been performed by hand. Thus, the plating solution management unit 302 can maintain each component in the plating solution within a predetermined range. Since a plating process is performed with a plating solution thus managed, it is possible to maintain good properties (components), good appearance, and good uniformity of the thickness of a plated film formed on the substrate.

The plating apparatus includes a communication device 304 for communicating information through a communication network using a computer. The communication device 304 transmits information on plating results or the like to proper units or devices through a communication network interconnecting the units or devices in the plating section 1, the ashing unit 300, the plating solution management unit 302, and the other units shown in FIG. 5. Thus, required information is mutually transmitted through the communication device 304 so as to control the units or devices based on the information to achieve a fully automatic plating process.

The plating apparatus also includes a resist stripping unit 306, a seed layer removal unit 308, an annealing unit 310, and a reflowing unit 312. The resist stripping unit 306 immerses the resist 502 formed as a mask on the substrate in a solvent, such as acetone, having a temperature of, for example, 50 to 60° C. to strip and remove the resist 502 after the plating process. The seed layer removal unit 308 removes portions of the seed layer 500 (see FIG. 1C), which have been unnecessary after the plating process, formed on a surface of the substrate. The annealing unit 310 anneals the plated film 504 (see FIG. 1D) formed on the surface of the substrate. The reflowing unit 312 reflows the plated film 504 formed on the surface of the substrate.

In the present embodiment, the plating apparatus has the annealing unit 310 and the reflowing unit 312. The plated film 504 is reflowed by the reflowing unit 312 to form a bump 506 (see FIG. 1E), which is rounded by surface tension. Alternatively, the plated film 504 is annealed, for example, at 100° C. or more by the annealing unit 310 to remove residual stress in the bump 506. The reflowing and annealing may simultaneously or individually be performed by a heat treatment unit.

From a viewpoint of continuous processing, it is desirable that the resist stripping unit 306 should strip a resist on a substrate while the substrate is held by a substrate holder, and that the seed layer removal unit 308 should remove unnecessary portions of a seed layer on a substrate while the substrate is held by a substrate holder. The substrate after stripping the resist or the substrate after removing the seed layer may be returned to a substrate cassette.

The plating apparatus includes a neutralization unit 314 having a neutralization tank for performing a neutralization treatment on a surface of a substrate immediately after the plating process. The neutralization unit (neutralization tank) 314 is configured to immerse a substrate, which has been plated and cleaned with water, in a neutralization treatment solution to perform neutralization treatment on the substrate. The neutralization treatment solution is set to be acescent or alkalescent so as to have characteristics opposite to the plating solution.

After the substrate has been plated and cleaned, acid or alkali components contained in the plating solution may remain on the substrate. According to the present embodiment, since the neutralization treatment is performed on the substrate immediate after the plating process, it is possible to eliminate adverse influence on the resist stripping process and the seed layer removal process, which are performed after the plating process, from acid or alkali. For example, the neutralization treatment solution may comprise an alkalescent solution containing trisodium phosphate.

The plating apparatus also includes a visual inspection unit 316 for inspecting an appearance of a plated film 504 formed on a surface of a substrate in a contact or non-contact manner. The visual inspection unit 316 performs visual inspection of the plated film 504 and notifies an operator through the communication device 304 when the plated film 504 has a defective appearance. At that time, the plating apparatus is halted, and the defective substrate is recorded in substrate processing data. Thus, the number of defective substrates can be reduced, and the defective substrates can be removed based on the substrate processing data.

Some substrate may have a defective appearance of a plated film 504 for various reasons including anomaly of a plating solution, a substrate, and a plating apparatus. If a plating process is continued without halting the plating apparatus when a defective substrate is produced, then the number of defective substrates is increased. The plating apparatus in the present embodiment can prevent such drawbacks.

The plating apparatus includes a film thickness measurement unit 318 for measuring the film thickness of a plated film 504 formed on a surface of a substrate in a contact or non-contact manner. The film thickness measurement unit 318 is configured to measure a distribution of the film thickness of the plated film 504 formed on the substrate over an overall surface of the substrate. Based on the measurement results, the film thickness measurement unit 318 determines whether or not the substrate has good quality. If the substrate does not have good quality, the substrate is recorded in substrate processing data. Based on a rate of defective substrates recorded in the substrate processing data, the plating apparatus is halted, and an operator is notified of the anomaly through the communication device 304.

The film thickness of a plated film formed on a substrate may vary according to influence from patterns formed on a substrate and conditions of the apparatus, the plating solution, and the substrate. In some cases, the within wafer uniformity of the film thickness of the plated film may excessively be lowered so as not to meet the specification limits. If the plating apparatus is operated to plate substrates continuously, then the number of defective substrate may be increased. Even if the within wafer uniformity of the film thickness is within the specification limits, a subsequent polishing process may be required according to the plating process. In such a case, it is necessary to set the amount of polishing to be required. In the present embodiment, the film thickness measurement unit 318 measures the film thickness of the plated film 504 so as to remove defective substrates, which has a low within wafer uniformity of the film thickness of the plated film, and to set the required amount of the plated film to be polished in a polishing unit 322.

The plating apparatus includes a plating area measurement unit 320 for measuring an actual area in which a plated film 504 is to be formed. The measurement is performed before the plating process by, for example, supplying a current to the substrate. A plating area is required to determine plating conditions. However, a plating area cannot be known or otherwise cannot accurately be known in some cases. In the present embodiment, an actual area (plating area) in which a plated film 504 is to be formed is measured before the plating process. Thus, a current value which determines plating conditions can be accurately determined. Accordingly, it is possible to accurately obtain a plated film having a predetermined film thickness in a predetermined plating time. In particular, in a case where a single substrate is plated at a time, substrates having different plating areas can be plated so as to have a predetermined film thickness merely by setting a current density and a plating period of time. Accordingly, setting of recipes is greatly facilitated.

The plating area measurement unit may comprise a measurement device for optically scan a surface of a substrate before the plating process to measure a plating area. For example, a substrate is sealed at a peripheral portion and detachably held by a substrate holder in a state such that a surface of a substrate to be plated is exposed externally. In such a case, when the surface of the substrate is optically scanned, a plating area can be measured readily and quickly.

The plating apparatus also includes a polishing unit 322 for polishing a surface of the plated film 504 (see FIG. 1E) of the substrate by chemical mechanical polishing (CMP) or mechanical polishing (MP) to adjust the film thickness of the plated film 504.

The plating apparatus includes a chemical liquid supply and recovery unit 324 for supplying a chemical liquid to the plating tank 34 and recovering the chemical liquid from the plating tank 34. Thus, the chemical liquid supply and recovery unit 324 supplies a chemical liquid to the plating tank 34 and recovers the chemical liquid from the plating tank 34. Accordingly, a highly corrosive or harmful chemical liquid which would exert an adverse influence not only on the apparatus or units but also on human bodies can readily be handled with safe because operators are not required to handle the chemical liquid so often.

The chemical liquid supply and recovery unit 324 is configured to supply a chemical liquid from a chemical liquid container, which is attached in a replaceable manner, to the plating tank 34 and to recover the chemical liquid from the plating tank 34 to the chemical liquid container. Specifically, a commercially available chemical liquid tank or bottle may be used as a chemical liquid container and attached in a replaceable manner. Thus, a chemical liquid is supplied directly from the available chemical liquid tank or bottle to the plating tank 34 and recovered from the plating tank 34 directly to the available chemical liquid tank or bottle.

When the chemical liquid tank or bottle becomes empty at the time of supply of the chemical liquid, an operator is notified, through the communication device 304, of a signal indicating that the chemical liquid tank or bottle should be replenished or replaced with a filled chemical liquid tank or bottle. At that time, the supply of the chemical liquid is interrupted. After the chemical liquid tank or bottle has been replenished or replaced with a filled chemical liquid tank or bottle, the supply of the chemical liquid is restarted.

When the chemical liquid tank or bottle becomes full at the time of recovery of the chemical liquid, an operator is notified, through the communication device 304, of a signal indicating that the chemical liquid tank or bottle should be replaced with an empty chemical liquid tank or bottle or the chemical liquid should be discharged from the chemical liquid tank or bottle. At that time, the recovery of the chemical liquid is interrupted. After the chemical liquid tank or bottle has been replaced with an empty chemical liquid tank or bottle or become empty, the recovery of the chemical liquid is restarted.

The plating apparatus includes a plating solution regeneration unit 326 for removing organic substances contained in a plating solution through an activated carbon filter to regenerate the plating solution. The plating apparatus has a plating solution circulation system (not shown) for flowing a plating solution through the plating solution regeneration unit 326, which includes a replaceable activated carbon filter, and the plating tank 34. With such a plating solution circulation system, the plating solution flows through the activated carbon filter in the plating solution regeneration unit 326 to remove organic substances as additives in the plating solution. Thus, a plating solution from which additive components (organic substances) are removed can be returned to the plating tank 34.

During the plating process, for example, a plating solution in which a component ratio of an additive such as an organic component or a surface-active agent is excessively increased beyond a predetermined range, or a plating solution in which an additive or a surface-active agent is decomposed but remains as a waste product can be regenerated by the plating solution regeneration unit 326 without replacement of the plating solution, so that cost and work for replacement with a new plating solution can remarkably be reduced. Particularly, together with use of the plating solution management unit 302, a plating solution can be regenerated to substantially the same degree as a new plating solution.

The plating apparatus includes an exhaust gas treatment unit 328 for removing harmful components from gas or mist produced in the plating apparatus and discharging harmless gas to an exterior of the apparatus through a duct. For example, the exhaust gas treatment unit 328 removes harmful components through a wet process with an absorption liquid, a dry process with an absorbent, or a condensation liquefaction process by cooling.

Generally, gas or mist produced in a plating apparatus is harmful to other apparatuses or facilities. An exhaust duct from a plating apparatus is generally connected and joined to a collective exhaust duct. Accordingly, an exhaust gas which has not been treated in the plating apparatus may react with an exhaust gas from other apparatuses so as to exert an adverse influence on other apparatuses or facilities. In the present embodiment, an exhaust gas from which harmful gas and mist have been removed by the exhaust gas treatment unit 328 is introduced into a collective exhaust duct to prevent an adverse influence on other apparatuses or facilities. Thus, it is possible to reduce loads on removing harmful components in other apparatuses or facilities.

In a case of a combination of a plating process with an acid plating solution and a plating process with a cyanic plating solution, the plating tank should preferably have a first chamber holding an acid plating solution and a second chamber holding a cyanic plating solution which are separated by a partition. It is desirable that the first chamber includes an exhaust duct to discharge an acid gas produced from the acid plating solution, and that the second chamber includes an exhaust duct to discharge a cyanic gas produced from the cyanic plating solution.

For example, if a plating process with an acid plating solution and a plating process with a cyanic plating solution are performed in the same plating apparatus, then the plating solutions or gas may be mixed to produce a cyanic gas. In order to prevent such a drawback, these processes have heretofore been performed in separate plating apparatuses. In the present embodiment, an acid gas produced from an acid plating solution and a cyanic gas produced from a cyanic plating solution can separately be discharged so as to prevent the plating solutions or gas from being mixed to produce a cyanic gas. Thus, a plating process with an acid plating solution and a plating process with a cyanic plating solution can be performed continuously in the same plating apparatus. The cyanic plating solution may comprise a gold plating solution or a silver plating solution.

The plating apparatus includes a waste water regeneration unit 330 for regenerating waste water, which has been used in and discharged from the plating process, to reuse a portion or all of regenerated waste water for the plating process while discharging the rest of the waste water to an exterior of the apparatus.

A cleaning process in the plating process requires a large amount of cleaning water. A large amount of cleaning water having high cleanliness and treatment of waste water which has been used in the plating process impose large loads on existing facilities. In the present embodiment, the plating apparatus has a completely or partially closed system for regenerating waste water used therein. Thus, it is possible to reduce the amount of cleaning water having high cleanliness and loads on waste water treatment required for the facilities. The waste water regeneration unit may be configured to regenerate the waste water by at least one of microfiltration, ultraviolet irradiation, ion exchange, ultrafiltration, and reverse osmosis.

The plating apparatus includes a chemical liquid adjustment unit 332 for removing metal impurities or organic impurities mixed in a plating solution or generated decomposition products. The chemical liquid adjustment unit 332 includes at least one of an electrolytic process section, an ion exchange section, an activated carbon process section, and a coagulation and settlement section.

In order to maintain evaluation properties of a deposited film, a plating solution used in a plating process should be renewed periodically according to levels of impurities mixed in the plating solution or accumulated decomposition products. An old plating solution is discarded except for particular plating solutions such as a gold plating solution, thereby causing loads on cost and environment. In the present embodiment, impurities and decomposition products contained in an old plating solution can be removed by the chemical liquid adjustment unit 332 so as to lengthen a frequency of renewal of a plating solution. Thus, it is possible to reduce loads on cost and environment.

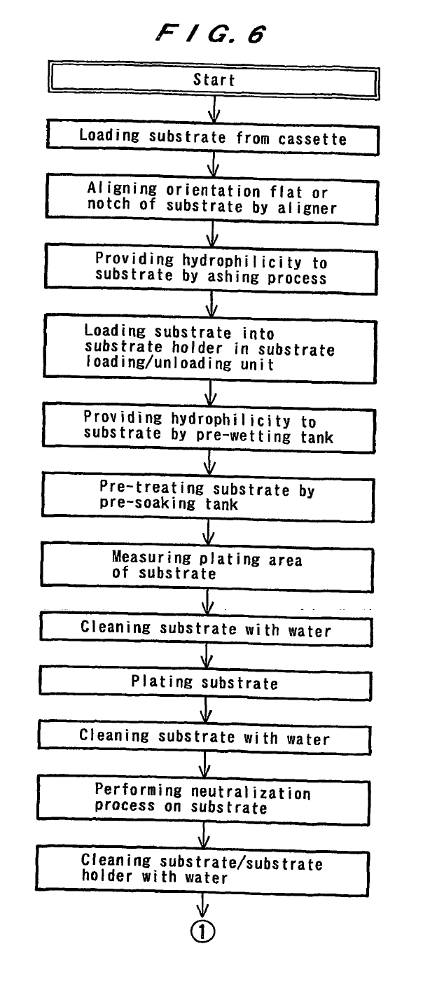

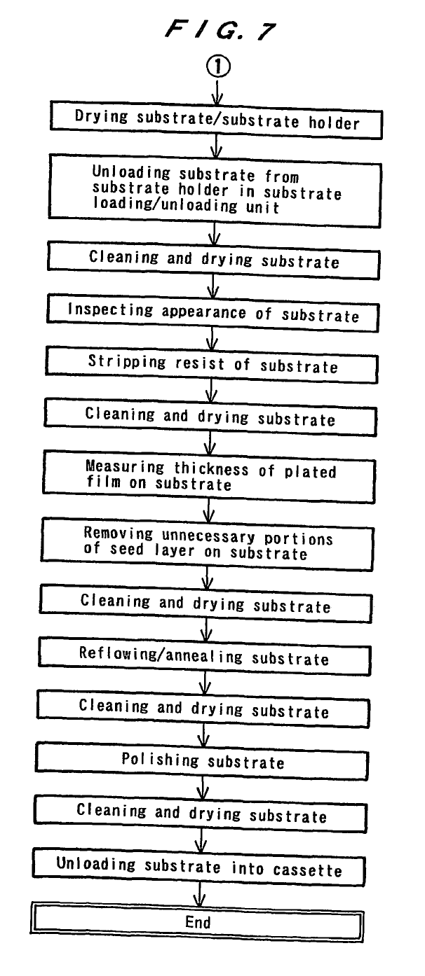

A bump plating process using the plating apparatus will be described below with reference to FIGS. 6 and 7. First, a seed layer 500 is deposited as a feeding layer on a surface of a substrate as shown in FIG. 1A. Then, a resist 502 is applied onto an overall surface of the seed layer 500 so as to have a height H of, for example, 20 to 120 μm. Thereafter, openings 502a having a diameter D of about 20 to about 200 μm are formed at predetermined positions in the resist 502. Substrates having such openings 502a are housed in a cassette 10 in a state such that surfaces of the substrates to be plated face upward. The cassette 10 is loaded on the cassette table 12.

The substrate transfer device 22 picks out one of substrates from the cassette 10 on the cassette table 12 and places it on the aligner 14 to align an orientation flat or a notch of the substrate in a predetermined direction. The substrate aligned by the aligner 14 is transferred to the ashing unit 300 to provide hydrophilicity to the resist 502 on a surface of the substrate by an ashing process. Then, the substrate after the ashing process is transferred to the substrate loading/unloading unit 20 by the substrate transfer device 22.

Two substrate holders 18 stored in the stocker 24 are lifted and transferred to the substrate loading/unloading unit 20 by the transporter 42 of the substrate holder transfer device 40. The substrate holders 18 are turned through 90° above the substrate holder transfer device 40 so as to be horizontally positioned. Then, the substrate holders 18 are lowered to place the two substrate holders 18 simultaneously onto the loading plate 52 in the substrate loading/unloading unit 20. At that time, the cylinder is actuated to open the movable support member 58 of the substrate holder 18 positioned near a central portion of the substrate loading/unloading unit 20.

The substrate transfer device 22 transfers the substrate and inserts it into the substrate holder 18. Then, the cylinder is actuated in an reverse manner to close the movable support member 58. Thereafter, the movable support member 58 is locked by the locking/unlocking mechanism. After the substrate has been loaded into one of the substrate holders 18, the loading plate 52 is slid horizontally so as to position the other of the substrate holders 18 at the central position of the substrate loading/unloading unit 20. Another substrate is loaded into the other of the substrate holders 18 in the same manner as described above, and then the loading plate 52 is returned to the original position.

In the substrate holder 18, a surface of the substrate to be plated is exposed through an opening of the substrate holder 18. The substrate is sealed at a peripheral portion thereof by a seal packing (not shown) so as to prevent a plating solution from entering the peripheral portion of the substrate. The substrate is electrically connected to a plurality of electric contacts at portions which are not brought into contact with the plating solution. The hands 76 of the substrate holder 18 are electrically connected to the electric contacts. The hands 76 are connected to a power supply to supply electric power to the seed layer 500 of the substrate.

Then, the two substrate holders 18 each having the substrate loaded are simultaneously held and lifted by the transporter 42 of the substrate holder transfer device 40. The substrate holders 18 are transferred to the stocker 24 and turned through 90° above the stocker 24 so as to be vertically positioned. Then, the substrate holders 18 are lowered so that the substrate holders 18 are held in a suspended manner in the stocker 24 and thus temporarily received in the stocker 24. The substrate transfer device 22, the substrate loading/unloading unit 20, and the transporter 42 of the substrate holder transfer device 40 repeat the above process so as to load substrates into substrate holders 18 which have been stored in the stocker 24 and hold (temporarily receive) the substrate holders 18 in a suspended manner at predetermined positions in the stocker 24.

The substrate holder 18 has a sensor for detecting contacting states between the substrate and the electrical contacts. When the sensor detects that the substrate is insufficiently held in contact with the electrical contacts, it outputs a signal indicating insufficient contact to a controller (not shown).

The transporter 44 of the substrate holder transfer device 40 holds two substrate holders 18 temporarily received in the stocker 24. The two substrate holders 18 are lifted and transferred to the pre-wetting tank 26 by the transporter 44. Then, the two substrate holders 18 are lowered and immersed into pure water held in the pre-wetting tank 26 to wet surfaces of the substrates with pure water for providing hydrophilicity to the surfaces of the substrates. Any liquid can be used as a pre-wetting liquid in the pre-wetting tank 26 as long as it can wet a surface of a substrate and can replace air bubbles in openings of the seed layer with the liquid so as to improve hydrophilicity of the surface of the substrate. As described above, the plating apparatus may have various kinds of pre-wetting portions so as to continuously perform two or more types of pre-wetting processes in the pre-wetting portions. In such a case, the plating apparatus can achieve various types of processes.

If a substrate is detected to be insufficiently held in contact with the electrical contacts by the sensor provided in the substrate holder 18, the substrate holder 18 having the substrate loaded therein is left temporarily received in the stocker 24. Thus, even if a substrate is insufficiently held in contact with electrical contacts when the substrate is loaded into the substrate holder 18, a plating process can be continued without interrupting operation of the plating apparatus. Although the substrate that is insufficiently held in contact with the electrical contacts is not plated, a substrate that has not been plated can be removed from the cassette after the cassette is returned.

Then, the substrate holders 18 with the substrate are transferred to the pre-soaking tank 28 in the same manner as described above. The substrates are immersed in a treatment solution such as a sulfuric acid or hydrochloric acid solution held in the pre-soaking tank 28 to etch an oxide film, which has a high electrical resistance, formed on the surface of the seed layer 500 so as to expose a clean metal surface as a pre-treatment process. The substrate thus pre-treated is transferred to the plating area measurement unit 320 to measure an actual area in which a plated film 504 is to be formed. The measurement is performed by, for example, supplying a current to the seed layer 500 of the substrate. Then, the substrate holders 18 with the substrates are transferred to the cleaning tank 30a, where surfaces of the substrates are cleaned with pure water held in the cleaning tank 30a.

The substrate holders 18 with the cleaned substrates are transferred to the plating tank 34 holding a plating solution and held in a suspended manner in each of the plating units 38. The transporter 44 of the substrate holder transfer device 40 repeats the above process so as to transfer substrate holders 18 with substrates to the plating units 38 in the plating tank 34 and hold the substrate holders 18 at predetermined positions in a suspended manner. After all of the substrate holders 18 have been held in a suspended manner, a plating voltage is applied between anodes 200 and seed layers 500 of the substrates while the plating solution overflows into the overflow tank 36. Simultaneously, the paddles 202 in the plating units 38 are reciprocated parallel to the surfaces of the substrates by the paddle driving units 46. Thus, the surfaces of the substrates are plated. At that time, the substrate holders 18 are supported in a suspended manner at the hands 76 on upper portions of the plating units 38. Electric power is supplied from a plating power supply through hand support portions, the hands 76, and electrical contacts to the seed layers 500 of the substrates.

The application of the plating voltage from the plating power supply, the supply of the plating solution, and the reciprocating movement of the paddles are stopped after the plating process has been completed. The two substrate holders 18 with the plated substrates are simultaneously held by the transporter 44 of the substrate holder transfer device 40 and transferred to the cleaning tank 30b. The substrate holders 18 are immersed in pure water held in the cleaning tank 30b to clean surfaces of the substrates with pure water. The substrate holders 18 with the substrates are transferred to the neutralization unit (neutralization tank) 314 and immersed into a neutralization treatment solution to perform a neutralization process. The substrates and the substrate holders 18 are cleaned with pure water after the neutralization process. Then, the substrate holders 18 with the substrates are transferred to the blowing tank 32 to remove water droplets attached to the substrate holders 18 and the substrates by blowing air so as to dry the substrate holders 18 and the substrates. The substrate holders 18 with the dried substrates are returned to the stocker 24 and held at the predetermined positions in a suspended manner.

The transporter 44 of the substrate holder transfer device 40 repeats the above process so as to return the substrate holders 18 with the plated substrates to the stocker 24 and to hold the substrate holders 18 at predetermined positions in a suspended manner.

The two substrate holders 18 with the plated substrates which have been returned to the stocker 24 are simultaneously held and placed on the loading plate 52 of the substrate loading/unloading unit 20 by the transporter 42 of the substrate holder transfer device 40. At that time, a substrate holder 18 that has been temporarily received in the stocker 24 because a substrate held in the substrate holder 18 is detected to be insufficiently held in contact with electrical contacts by the sensor provided in the substrate holder 18 is also transferred and placed on the loading plate 52 of the substrate loading/unloading unit 20.

Then, the movable support member 58 of the substrate holder 18 positioned at the central portion of the substrate loading/unloading unit 20 is unlocked by the locking/unlocking mechanism. The cylinder is actuated to open the movable support member 58. In this state, the plated substrate in the substrate holder 18 is picked out and transferred to the cleaning and drying device 16 by the substrate transfer device 22. In the cleaning and drying device 16, the substrate is cleaned and rotated at a high speed to spin-dry the substrate. Then, the loading plate 52 is slid horizontally. The substrate held by the other substrate holder 18 is cleaned and dried in the same manner as described above.

After the loading plate 52 is returned to the original position, the two substrate holders 18 from which the substrates are unloaded are simultaneously held by the transporter 42 of the substrate holder transfer device 40 and returned to the predetermined positions in the stocker 24. Then, the two substrate holders 18 with the plated substrates which have been returned to the stocker 24 are simultaneously held and placed on the loading plate 52 of the substrate loading/unloading unit 20 by the transporter 42 of the substrate holder transfer device 40. Thus, the processes as described above are repeated. All of the substrates are unloaded from the substrate holders 18 with the plated substrates which have been returned to the stocker 24 and cleaned and dried. Thus, as shown in FIG. 1B, it is possible to obtain substrates W having plated films 504 grown in the openings 502a formed in the resist 502.

Next, the cleaned and dried substrate is transferred to the visual inspection unit 316 to inspect an appearance of the plated films 504 formed on the surface of the substrate. The inspected substrate is transferred to the resist stripping unit 306, where the substrate is immersed in a solvent, such as acetone, having a temperature of, for example, 50 to 60° C. to strip and remove the resist 502 on the substrate as shown in FIG. 1C. Then, the substrate from which the resist 502 has been removed is cleaned and dried.

The cleaned substrate is transferred to the film thickness measurement unit 318 to measure a distribution of the film thickness of the plated film 504. The measured substrate is transferred to the seed layer removal unit 308, where unnecessary portions of the seed layer 500 which are exposed are removed after the plating process. Then, the substrate from which the unnecessary portions of the seed layer 500 are removed is cleaned and dried.

The substrate is transferred to the reflowing unit 312, which comprises, for example, a diffusion furnace, to reflow the plated films 504 so as to form bumps 506 which have been rounded due to surface tension as shown in FIG. 1E. Alternatively, the substrate may be transferred to the annealing unit 310 to anneal the substrate at a temperature of 100° C. or more so as to remove residual stress in the bumps 506. Then, the reflowed or annealed substrate is cleaned and dried.

The cleaned substrate is transferred to the polishing unit 322 to polish surfaces of the bumps 506 (or the plated films 504) so as to adjust the film thickness of the substrate. The polished substrate is cleaned and dried. Then, the substrate is returned or unloaded to the cassette 10. Thus, a sequence of processes is completed.

In the present embodiment, the substrate transfer device 22 has a dry hand and a wet hand. The wet hand is used only when a plated substrate is picked out from the substrate holder 18. The dry hand is used except when a plated substrate is picked out from the substrate holder 18. Because the substrate holder 18 seals a rear face of the substrate so that the rear face of the substrate is not brought into contact with a plating solution, it is not necessary to use a wet hand to handle the substrate. However, since the dry hand and the wet hand are separately used, even if a plating solution contaminates a substrate because of a flow of rinse water or insufficient sealing, such contamination does not cause a rear face of another substrate to be contaminated.

Bumps formed by multilayer plating include Ni—Cu-solder, Cu—Au-solder, Cu—Ni-solder, Cu—Ni—Au, Cu—Sn, Cu—Pd, Cu—Ni—Pd—Au, Cu—Ni—Pd, Ni-solder, Ni—Au, and the like. The solder may comprise high melting point solder or eutectic solder. Alternatively, bumps may be formed by Sn—Ag multilayer plating or Sn—Ag—Cu multilayer plating and reflowed to alloy the multilayer. Because such a process does not use Pb unlike a conventional Sn—Pb solder, environmental problems which would otherwise be caused by lead can be eliminated.

As described above, the plating apparatus in the present embodiment can automatically perform a dipping-type electroplating process on a substrate and form plated metal films suitable for bumps on a surface of the substrate when the apparatus is operated after a cassette housing substrates is loaded on a cassette table.

In the present embodiment, while the substrate is held in a sealed manner at a peripheral portion and a rear face by a substrate holder, the substrate is transferred together with the substrate holder for various processes. However, substrates may be received and transferred in a substrate transfer device having a rack. In this case, a thermally oxidized layer (Si oxide layer), an adhesive tape film, or the like may be applied to a rear face of a substrate to prevent the rear face of the substrate from being plated.

In the present embodiment, a dipping-type electroplating process is automatically performed to form bumps on a substrate. However, a jet-type or cup-type electroplating process, in which a plating solution is ejected upward, may automatically be performed to form bumps on a substrate. This also holds true in the following embodiments.

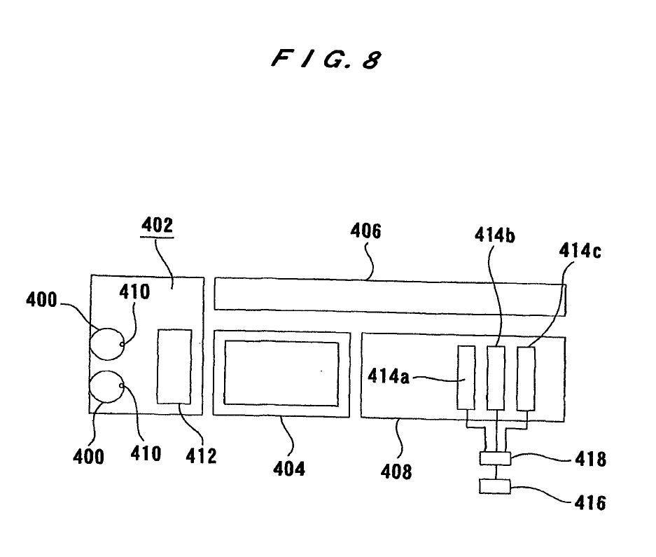

FIG. 8 is a schematic plan view showing a plating apparatus according to a second embodiment of the present invention. As shown in FIG. 8, the plating apparatus has a loading/unloading section 402 for loading and unloading cassettes 400 which house substrates such as semiconductor wafers therein, a tool stocker 404 for storing a plurality of types of tools (substrate holders) which correspond to the sizes of substrates to be plated, a transfer device 406 for transferring a substrate together with a tool holding the substrate, and a plating section 408.

The loading/unloading section 402 has sensors 410 provided at cassette holding portions on which cassettes 400 are mounted. The sensors 410 detect the sizes of the substrates received in the cassettes 400 on the cassette holding portions. Further, the loading/unloading section 402 has a substrate loading/unloading unit 412 disposed near the tool stocker 404 for loading a substrate onto and unloading a substrate from a tool. The substrate is transferred from the cassette 400 to the substrate loading/unloading unit 412 by a transfer robot (not shown).

The tool stocker 404 stores a plurality of types of tools (substrate holders) which correspond to the sizes of substrates to be plated. The tools include a substrate holder having substantially the same structure as shown in FIG. 3 which has the same shape as shown in FIG. 3 but can detachably hold a substrate having a diameter of, for example, 200 mm or 300 mm.

The plating section 408 includes a plurality of types of plating tanks to perform various plating processes. In the present embodiment, the plating tanks include a copper plating tank 414a to perform a copper plating process, a nickel plating tank 414b to perform a nickel plating process, and a gold plating tank 414c to perform a gold plating process. The substrate is sequentially transferred to the plating tank 414a, 414b, and 414c by the transfer device 406. Thus, various plating processes are sequentially performed to form bumps having a Cu—Ni—Au multilayer. The plating tanks are not limited to the plating tanks as described above.

In the present embodiment, the plating section 408 has a single plating power supply 416. The power supply 416 selectively supplies electric power through a switch 418 between a substrate and anodes of the plating tanks in which the substrate is immersed, so that the substrate is sequentially plated in the copper plating tank 414a, the nickel plating tank 414b, and the gold plating tank 414c. The plating apparatus may include a sensor (not shown) for detecting when a substrate is immersed in the plating solutions of said plurality of plating tanks. In such a case, the switch 418 switches the power supply 416 based on a signal from the sensor.

Thus, the use of the single plating power supply 408 can reduce the number of plating power supplies. Accordingly, the plating apparatus can be made compact in size. Further, when troubles occur in the plating power supply, the plating process can be interrupted before a substrate has been plated or while a substrate is plated. Accordingly, it is not necessary to discard the substrate, and the substrate can be plated by the plating power supply that has been repaired.

The plating processes in the plating apparatus will be described below. First, a seed layer 500 is deposited on a surface of a substrate as shown in FIG. 1A. Then, a resist 502 is applied onto an overall surface of the seed layer 500. Thereafter, openings 502a are formed at predetermined positions in the resist 502. Substrates having such openings 502a are housed in a cassette 400. The cassette 400 is introduced into the loading/unloading section 402 and loaded on the cassette holding portion of the loading/unloading section 402. At that time, the sensor 410 provided at the cassette holding portion detects the sizes of the substrates housed in the cassette 400 and sends a signal to a controller (not shown).

The controller sends the signal to the transfer device 406, which selects a tool having a size suitable for a substrate housed in the cassette 400 introduced into the loading/unloading section 402, picks out the tool from the tool stocker 404, and transfers the tool to the substrate loading/unloading unit 412. A substrate is picked out from the cassette 400 by the transfer robot (not shown) and transferred to the substrate loading/unloading unit 412. The substrate is held by the tool in the substrate loading/unloading unit 412.

The transfer device 406 holds the substrate together with the tool and performs a necessary process such as pretreatment on a surface of the substrate. Then, the transfer device 406 transfers the substrate to the copper plating tank 414a and immerses the substrate in a plating solution of the copper plating tank 414a to form plated copper films on a surface of the seed layer 500. The transfer device 406 transfers the substrate together with the tool to the nickel plating tank 414b and immerses the substrate in a plating solution of the nickel plating tank 414b to form plated nickel films on a surface of the plated copper film. The transfer device 406 transfers the substrate together with the tool to the gold plating tank 414c and immerses the substrate in a plating solution of the gold plating tank 414c to form plated gold films on a surface of the plated nickel film. Thus, bumps of Cu—Ni—Au alloy are formed on the surface of the substrate. The substrate on which the bumps are formed is returned from the substrate loading/unloading unit 412 to the cassette 400. As with the first embodiment, necessary processes such as cleaning are performed between these plating processes or after these plating processes.

If the plating apparatus is designed so as to correspond to the size of a substrate to be plated, then a plurality of plating apparatuses are required to correspond various sizes of substrates. Accordingly, a large space for installation and utilities such as a power supply are required in a clean room. According to the present embodiment, a single plating apparatus can perform a plating process on substrates having different sizes, so that a required space in a clean room, which is expensive, required energy, and required cost can be reduced while substrates having different sizes are plated.

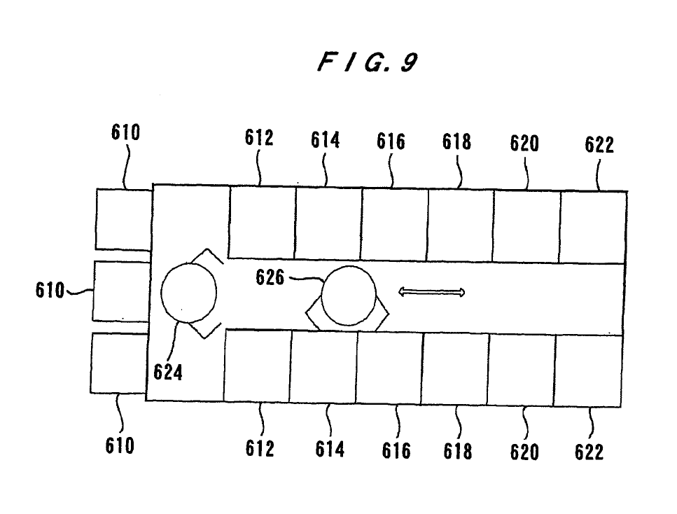

FIG. 9 is a schematic plan view showing a plating apparatus according to a third embodiment of the present invention. As shown in FIG. 9, the plating apparatus has one or more cassette tables 610 each for loading and unloading a substrate cassette housing substrates such as semiconductor wafers, two cleaning units 612, two pre-treatment units 614, two plating units 616, two resist stripping units 618, two etching units 620, and two reflowing units 622. In the illustrated example, the plating apparatus has three cassette tables 610. The cleaning units 612, the pre-treatment units 614, the plating units 616, the resist stripping units 618, the etching units 620, and the reflowing units 622 are independent of each other. As shown in FIG. 9, these units are incorporated integrally with each other so as to form two lines each including different types of units.

The plating apparatus also has a first transfer robot 624 disposed between the cassette tables 610 and the cleaning units 612 for transferring a substrate between the cassette tables 610 and the cleaning units 612, and a second transfer robot 626 disposed between the two lines of the units for transferring a substrate between these units. The second transfer robot 626 is movable along the lines of the units.

For example, the cleaning units 612 may immerse a substrate in pure water so as to bring a surface of the substrate into contact with pure water to clean (or rinse) the substrate and then spin-dry the substrate. For example, the pre-treatment units 614 may be configured to immerse a substrate in a treatment solution such as a sulfuric acid or hydrochloric acid solution to etch an oxide film, which has a high electrical resistance, formed on a surface of the substrate so as to expose a clean metal surface. Alternatively, the pre-treatment units 614 may uniformly apply a pre-treatment solution (pre-dipping solution), which constitutes a portion of a plating solution, onto a surface of a substrate so that a plating solution is more likely to adhere to the surface of the substrate.

For example, the plating units 616 may perform an electroplating process on openings formed in a surface of a substrate. For example, the resist stripping units 618 may be configured to strip and remove a resist film remaining on a surface of a substrate. For example, the etching units 620 may etch and remove unnecessary portions of a seed layer, which are other than bumps formed on a surface of a substrate. For example, the reflowing units 622 may be configured to heat and reflow a substrate to melt a plated film and form hemisphere bumps on a surface of a substrate.

The plating processes in the plating apparatus will be described below. First, a seed layer 500 is deposited as a feeding layer on a surface of a substrate by sputtering or vapor deposition, as shown in FIG. 1A. Then, a resist 502 is applied onto an overall surface of the seed layer 500 so as to have a height H of, for example, 20 to 120 μm. Thereafter, openings 502a having a diameter D of about 20 to about 200 μm are formed at predetermined positions in the resist 502. Substrates having such openings 502a are housed in a substrate cassette. The substrate cassette is loaded on the cassette table 610.

The first transfer robot 624 picks out one of substrates from the substrate cassette on the cassette table 610 and transfers it to one of the cleaning units 612 to clean a surface of the substrate with pure water. The cleaned substrate is transferred to one of the pre-treatment units 614 by the second transfer robot 626 to perform a pre-treatment process on a substrate. In the pre-treatment unit 614, the substrate is immersed in a treatment solution such as a sulfuric acid or hydrochloric acid solution, or a pre-treatment solution (pre-dipping solution), which constitutes a portion of a plating solution, is uniformly applied onto a surface of a substrate.

The pre-treated substrate is cleaned by one of the cleaning units 612 as needed. Then, the substrate is transferred to one of the plating units 616 by the second transfer robot 626 to perform an electroplating process on a surface of the substrate. Thus, as shown in FIG. 1B, it is possible to obtain a substrate W having a plated film 504 grown in the openings 502a formed in the resist 502.

The plated substrate W is cleaned by one of the cleaning units 612 as needed. Then, the substrate is transferred to one of the resist stripping units 618 by the second transfer robot 626 to immerse the substrate in a solvent, such as acetone, having a temperature of, for example, 50 to 60° C. to strip and remove the resist 502 on the substrate as shown in FIG. 1C.

The substrate from which the resist 502 has been removed is cleaned as needed. Then, the substrate is transferred to one of the etching units 620 by the second transfer robot 626 to etch and remove unnecessary portions of a seed layer 500, which are exposed after the plating process, as shown in FIG. 1D.

The etched substrate is cleaned by one of the cleaning units 612 as needed. Then, the substrate is transferred to one of the reflowing units 622 by the second transfer robot 626 to heat and reflow the plated film 504 of the substrate so as to form bumps rounded due to surface tension as shown in FIG. 1E. Further, the substrate is annealed at a temperature of 100° C. or more so as to remove residual stress in the bumps 506.

The reflowed substrate is transferred to one of the cleaning units 612 by the second transfer robot 626. In the cleaning unit 612, the substrate is cleaned with pure water and spin-dried. The spin-dried substrate is returned to the substrate cassette mounted on the cassette table 610 by the first transfer robot 624.

As described above, according to the present embodiment, a bump formation process including a plating process can be performed continuously so as to reduce a space for the apparatus. Since the plating apparatus includes independent units for performing various processes, the plating apparatus can flexibly achieve a desired plating process.

Although certain preferred embodiments of the present invention have been shown and described in detail, it should be understood that various changes and modifications may be made therein without departing from the scope of the appended claims.

### INDUSTRIAL APPLICABILITY

The present invention is suitable for use in a plating apparatus for forming a bump (protruding electrode), which provides electrical connection with an electrode of a package or a semiconductor chip, on a surface of a semiconductor wafer with use of a resist as a mask.

1-60. (canceled)

61. A plating apparatus comprising:
a loading/unloading section configured to load and unload a cassette housing substrates;
a sensor provided in said loading/unloading section for detecting sizes of the substrates received in the cassette;
a plurality of tools corresponding to sizes of substrates to be plated;
a tool stocker to store said plurality of tools;
a plating section configured to perform at least a plating process;
a controller configured to select a tool corresponding to a size detected by said sensor from said plurality of tools; and
a transfer device configured to hold and transfer said tool selected by said controller to said plating section.

62. The plating apparatus according to claim 1, wherein said plating section includes:
a plurality of plating tanks each having a plating solution and an anode therein; and
a single power supply configured to selectively apply a voltage between a substrate and anodes in said plurality of plating tanks so as to perform sequential plating processes.

63. The plating apparatus as recited in claim 2, wherein said plurality of plating tanks contain different kinds of metals.

64. The plating apparatus as recited in claim 2, further comprising:
a sensor for detecting when a substrate is immersed in the plating solutions of said plurality of plating tanks; and
a switch operable to switch said single power supply based on a signal from said sensor.
